(19) United States
(12) Patent Application Publication
(10) Pub. No.: US 2026/0027007 A1
(43) Pub. Date: Jan. 29, 2026

(54) Manual Medicine Distributing Apparatus

(71) Applicant: Takazono Corporation, Kadoma-shi (JP)

(72) Inventor: Chikako Matsumoto, Kadoma-shi (JP)

(21) Appl. No.: 18/874,185

(22) PCT Filed: Aug. 28, 2023
(86) PCT No.: PCT/JP2023/030971

§ 371 Date: Oct. 10, 2025

(30) Foreign Application Priority Data
Sep. 13, 2022 (JP) 2022-145149

(51) Int. Cl. A61J 1/03; A61J 1/14

(52) U.S. Cl. CPC A61J 1/03; A61J 1/1475

(57) ABSTRACT

A manual medicine distributing apparatus includes: a plurality of indicators disposed to correspond respectively to the plurality of receiving parts for color-coded indication of those receiving parts into which the medicine should be placed; a controller part configured to control the plurality of indicators. The controller part is configured to control indicators of some or all of those receiving parts into which the medicine should be placed out of the plurality of receiving parts to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription, and configured to switch between the first mode and the second mode.

### CROSS-REFERENCE TO RELATED APPLICATIONS

This application is the United States national phase of International Patent Application No. PCT/JP2023/030971 filed Aug. 28, 2023, and claims priority to Japanese Patent Application No. 2022-145149 filed Sep. 13, 2022, the disclosures of which are hereby incorporated by reference in their entireties.

### BACKGROUND OF THE INVENTION

### Field of the Invention

The present invention relates to a manual medicine distributing apparatus for manually distributing medicine.

### Description of Related Art

Conventionally, a manual medicine distributing apparatus described in Patent Literature 1 is known. The manual medicine distributing apparatus includes: a manual distributing unit including a plurality of cells in which medicine is manually placed, and a plurality of LEDs disposed adjacent to the respective cells; and a controller part for controlling emission of the LEDs, and the controller part is configured to allow specific LEDs to emit light in a specific color, the specific LEDs corresponding to those cells into which specific medicine to be taken at a specific timing should be placed.

According to such a manual medicine distributing apparatus, the LEDs adjacent to the respective cells are configured to emit in different colors depending on different timings of taking the medicine. This configuration allows an operator to easily identify the timing of taking the medicine to be placed into each cell, and is thus deemed to facilitate identification of which medicine should be placed in a specific cell.

### CITATION LIST

### Patent Literature

Patent Literature 1: JP 2018-143769 A

### SUMMARY OF THE INVENTION

### Technical Problem

The manual medicine distributing apparatus as described in Patent Literature 1 is configured to allow the operator to identify the timing of taking the medicine in the corresponding cell, but still has some room for further improved usability.

It is therefore an object of the present invention to provide a manual medicine distributing apparatus with good usability.

### Solution to Problem

A manual medicine distributing apparatus of the present invention is a manual medicine distributing apparatus including a receiving body including a plurality of receiving parts in which medicine can be received, the plurality of receiving parts being open upward and configured to allow an operator to manually place the medicine thereinto from above, the manual medicine distributing apparatus including: a plurality of indicators disposed to correspond respectively to the plurality of receiving parts for color-coded indication of those receiving parts into which the medicine should be placed; a controller part configured to control the plurality of indicators; and an input part for receiving an external input, in which the controller part is configured to control indicators of some or all of those receiving parts into which the medicine should be placed out of the plurality of receiving parts to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription input to the input part, and configured to switch between the first mode and the second mode based on an input by the operator to the input part.

### BRIEF DESCRIPTION OF THE DRAWINGS

FIG. 1 is a perspective view showing a medicine packaging apparatus including a manual medicine distributing apparatus according to one embodiment of the present invention.

FIG. 2 is a plan view showing a receiving body of the manual medicine distributing apparatus.

FIG. 3 is an enlarged view of a portion III shown in FIG. 2.

FIG. 4 is a cross-sectional view taken along IV-IV shown in FIG. 2.

FIG. 5 is a view showing an operating state of receiving body-side indicators of the manual medicine distributing apparatus.

FIG. 6 is a view showing a first example of color-coded indication of the receiving body-side indicators of the manual medicine distributing apparatus.

FIG. 7 is a view showing a first example of color-coded indication of screen-side indicators of the manual medicine distributing apparatus.

FIG. 8 is a view showing a second example of color-coded indication of the screen-side indicators of the manual medicine distributing apparatus.

FIG. 9 is a view showing a third example of color-coded indication of the receiving body-side indicators of the manual medicine distributing apparatus.

FIG. 10 is a view showing a third example of color-coded indication of the screen-side indicators of the manual medicine distributing apparatus.

FIG. 11 is a view showing a fourth example of color-coded indication of the receiving body-side indicators of the manual medicine distributing apparatus.

FIG. 12 is a view showing a fourth example of color-coded indication of the screen-side indicators of the manual medicine distributing apparatus.

FIG. 13 is a view showing a fifth example of color-coded indication of the receiving body-side indicators of the manual medicine distributing apparatus.

FIG. 14 is a view showing a fifth example of color-coded indication of the screen-side indicators of the manual medicine distributing apparatus.

### DESCRIPTION OF THE INVENTION

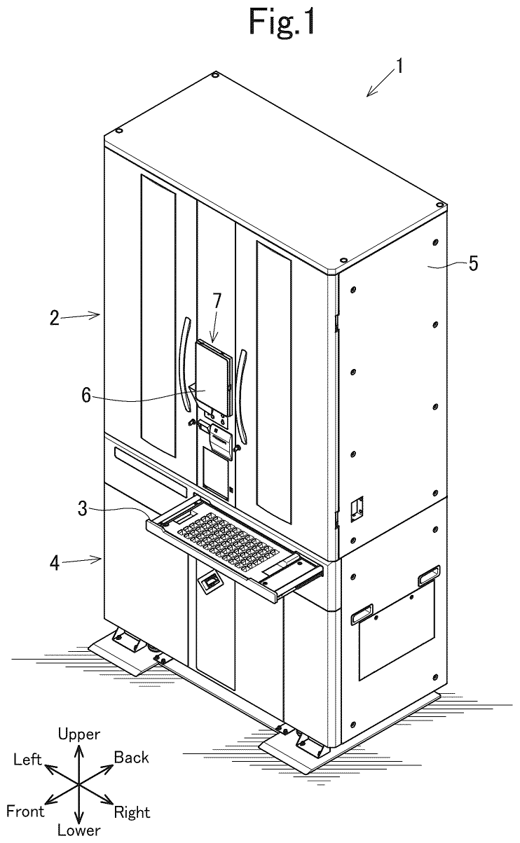

A manual medicine distributing apparatus 3 according to one embodiment of the present invention will be described with reference to FIG. 1 to FIG. 14. A description on vertical, right-left, and depth directions will be given based on the directions of the apparatus when installed. Specifically, the depth direction refers to a direction orthogonal to a front surface of a housing 5, and a description will be given with a front side being a near side and a back side being a far side.

The manual medicine distributing apparatus 3 of this embodiment is configured as a part of a medicine packaging apparatus 1 for packaging medicine. First, a description will be given on the medicine packaging apparatus 1 with reference to FIG. 1.

The medicine packaging apparatus 1 is an apparatus configured to package medicine per dose in a package such as packaging paper. Specifically, the medicine packaging apparatus 1 includes: an automatic feeding apparatus 2 including a plurality of cassettes (not shown) in which the medicine is stored, and capable of feeding the medicine stored in the cassettes; the manual medicine distributing apparatus 3 configured to feed the manually distributed medicine; a packaging part 4 configured to package the medicine fed from the automatic feeding apparatus 2 and the manual medicine distributing apparatus 3 in the package; and a housing 5 having a box shape for housing the automatic feeding apparatus 2, the manual medicine distributing apparatus 3, and the packaging part 4 therein. The medicine packaging apparatus 1 further includes an input part 6 capable of inputting various information through reception of external information or operation by the operator, and a controller part for controlling the entire medicine packaging apparatus 1. In this embodiment, both the medicine stored in the cassettes and the medicine placed into the manual medicine distributing apparatus 3 are tablets or capsules.

The automatic feeding apparatus 2 has a plurality of types of medicine stored therein. Specifically, in the automatic feeding apparatus 2, the plurality of types of medicine are stored in the separate cassettes. Further, the automatic feeding apparatus 2 is configured to feed the stored medicine to the packaging part 4 in response to an instruction from the controller part. The automatic feeding apparatus 2 can also include a plurality of cassettes storing a single type of medicine to be fed in a large amount.

The packaging part 4 is a portion for packaging doses of the medicine fed from the automatic feeding apparatus 2 and the manual medicine distributing apparatus 3 in the separate packages. The packaging part 4 is a portion disposed below the automatic feeding apparatus 2 and the manual medicine distributing apparatus 3. In this embodiment, the medicine fed from the automatic feeding apparatus 2 and the manual medicine distributing apparatus 3 moves by gravity through a medicine feeding passage (not shown) within the housing 5, and is fed to the packaging part 4.

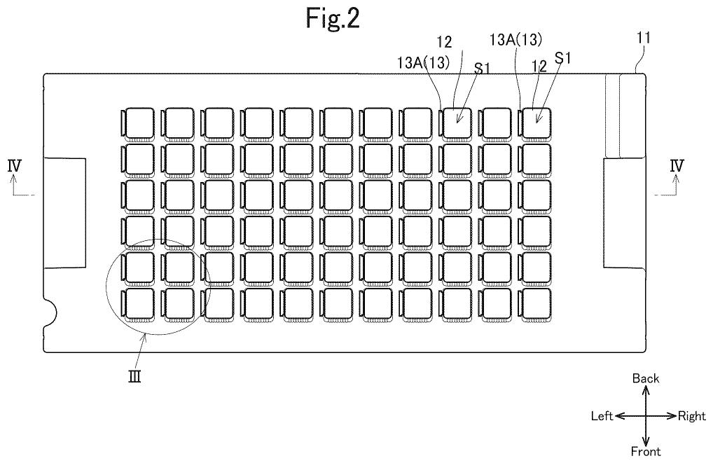

As shown in FIG. 1 and FIG. 2, the manual medicine distributing apparatus 3 is configured to allow the medicine to be placed thereinto by manual distribution, and in this embodiment configured to feed the placed medicine to the packaging part 4. Specifically, the manual medicine distributing apparatus 3 includes: a receiving body 11 including a plurality of receiving parts 12 in which the manually distributed medicine can be received; a plurality of indicators 13 each configured to indicate each corresponding one of the receiving parts 12 into which the medicine should be placed; a destaticizer (not shown) configured to eliminate static electricity from the medicine in the receiving body 11 before being fed to the packaging part 4; the housing 5 for housing the receiving body 11, the indicators 13, and the packaging part 4 therein; and a display screen 7 for displaying various information. The housing 5 of this embodiment is formed as the housing 5 of the medicine packaging apparatus 1. The housing 5 has a housing space thereinside, in which the receiving body 11 can be housed. The manual medicine distributing apparatus 3 further includes the input part 6 capable of inputting information on manual distribution of the medicine; and the controller part configured to control the entire manual medicine distributing apparatus 3. The input part 6 and the controller part of this embodiment are configured integrally with the input part 6 and the controller part of the medicine packaging apparatus 1. Further, at least part of the input part 6 is displayed in the form of buttons on the display screen 7, and the input part 6 of this embodiment is a touch panel configured integrally with the display screen 7.

As shown in FIG. 2, the receiving body 11 includes the plurality of receiving parts 12 each defining a receiving area S1 as a recess in which the medicine can be received, and has a plate shape having a smaller thickness (i.e., dimension in the vertical direction) than a depth dimension (i.e., dimension in the depth direction) and a width direction (i.e., dimension in a direction orthogonal to the vertical direction and the depth direction). Further, the receiving body 11 includes the plurality of receiving parts 12 arranged in a horizontal direction. In the receiving body 11 of this embodiment, a plurality of rows of the receiving parts 12 are disposed, each row including the receiving parts 12 arranged in the depth direction. Further, the receiving body 11 of this embodiment includes 11 rows of the receiving parts 12, each row including six receiving parts 12 arranged in the depth direction to count 66 receiving parts 12 in total (i.e., for 22 days in the case of “3 divided doses (i.e., the medicine is to be taken three times a day)”). The receiving body 11 is a plate-like body disposed to have its thickness direction coinciding with the vertical direction. The receiving body 11 of this embodiment is a plate-like body disposed to have its long side direction and its short side direction coinciding respectively with the right-left direction and the depth direction.

The receiving body 11 of this embodiment is configured to be movable between a housed position at which the receiving body 11 is housed within the housing space of the housing 5 and a projecting position (position shown in FIG. 1) at which the receiving body 11 projects outside the housing 5. Specifically, the receiving body 11 is configured to substantially horizontally slide forward from the housed position to move to the projecting position. In this embodiment, the receiving body 11 is configured to automatically move between the housed position and the projecting position, without limitation thereto, and the configuration can be such that the receiving body 11 manually moves therebetween.

As shown in FIG. 2 to FIG. 4, each of the plurality of receiving parts 12 is a box-shaped portion that opens upward and into which the operator can manually place the medicine from above. The receiving part 12 has an inner wall surface 15 defining the receiving area S1 in which the medicine can be received. Specifically, the receiving part 12 includes a bottom part 16 having a bottom surface 16a that forms a bottom of the receiving area S1, and a side wall 17 having a side surface 17a that defines a side of the receiving area S1. The side wall 17 is configured as a partition wall for separating the receiving areas S1 of each two receiving parts 12 disposed adjacent to each other.

The bottom part 16 is a bottom plate configured to be openable. Specifically, the bottom part 16 is in a closed state when the medicine is placed into the receiving area S1, and is in an open state when the medicine in the receiving area S1 is fed to the packaging part 4. That is, the bottom part 16 is configured to be switchable by being opened and closed between the state where the placed medicine is held within the receiving area S1 and the state where the placed medicine is fed to the packaging part 4. The bottom part 16 of this embodiment is opened in the housed state to allow the medicine within the receiving area S1 to fall freely to be fed to the packaging part 4 located below. Further, the bottom part 16 of this embodiment is composed of an electrically grounded conductor. Specifically, the bottom part 16 is a plate-like body made of a metal and electrically grounded via the medicine packaging apparatus 1.

The side wall 17 is a wall body erecting upward from an outer edge portion of the bottom surface 16a. The side wall 17 has a tapered shape with a lower end side of the receiving area S1 being narrower and an upper end side thereof being wider. Further, the side wall 17 has an unevenness 18 on an inner surface. On the inner surface of the side wall 17 of this embodiment, a plurality of grooves extending along the vertical direction are formed as the unevenness 18. In the side wall 17 of this embodiment, the unevenness 18 (i.e., the plurality of grooves) extending along the vertical direction is formed at least on a back side surface. The unevenness 18 of this embodiment is formed on each of four inner surfaces of the side wall 17. The side wall 17 is a hollow wall body with a space for allowing the indicator 13 to be housed therein. That is, the side wall 17 is configured to allow the indicator 13 to be disposed between each adjacent receiving areas S1. Further, the unevenness 18 also serves as grooves for suppressing the medicine from being tightly held to the side wall 17.

An upper end surface of the receiving part 12 surrounding the receiving area S1 is provided with an identification mark 19 for identifying the receiving part 12. The identification mark 19 is a mark located at a position adjacent to the receiving area S1. The identification mark 19 of this embodiment is a numerical figure shown on a left side of the receiving area S1 of each receiving part 12. Further, the numerical figure shown as the identification mark 19 represents the order in which the medicine placed in the corresponding receiving part 12 is packaged. That is, for example, the medicine placed in the receiving area S1 of the receiving part 12 with the identification mark 19 of “5” on the left side is packaged in the fifth package. The identification mark 19 of this embodiment is printed on the upper end surface of the receiving part 12. Further, the identification mark 19 is shown to be identifiable when viewed from the front side of the receiving body 11. That is, the numerical figure as the identification mark 19 of this embodiment is shown to have a lower portion directed to the front side and an upper portion directed to the back side. The identification mark 19 can be placed on the upper surface (i.e., second surface 27) of a light transmissive part 23, which will be described later.

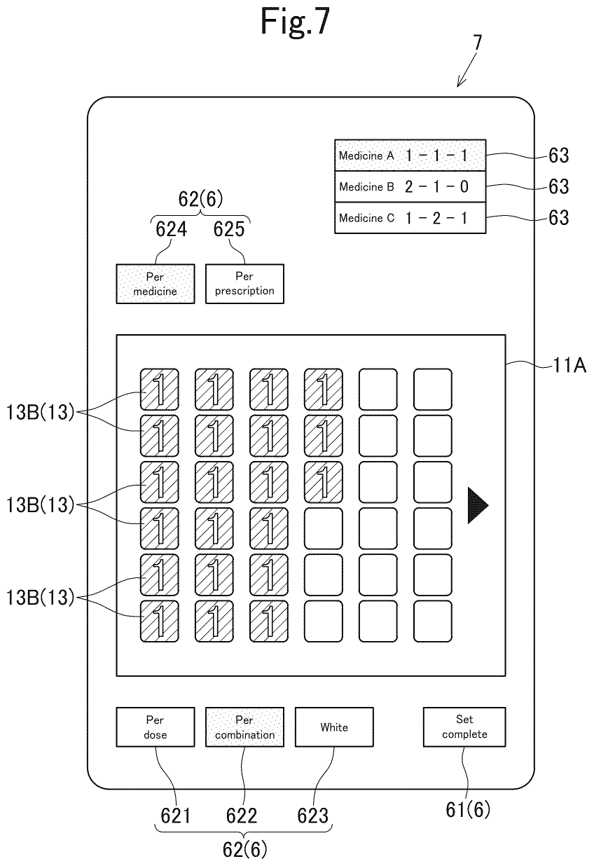

The indicators 13 are disposed to correspond to the respective receiving parts 12 to indicate those receiving parts 12 into which the medicine should be placed. The indicators 13 of this embodiment are configured to differentiate the respective receiving parts 12 through color-coded indication based on prescription information. Specifically, the indicators 13 include receiving body-side indicators 13A on the receiving part 11 and arranged to correspond to the respective receiving parts 12; and, as shown in FIG. 7, screen-side indicators 13B on a virtual receiving body 11A, which is a virtually provided receiving body 11 displayed on the display screen 7, and arranged to correspond to the respective receiving parts 12 of the virtual receiving body 11A. The screen-side indicators 13B of this embodiment each are a cell of the virtual receiving body 11A, and the cell is emitted with light in color based on the control of the controller part. Further, the indicators 13 of this embodiment are controlled by the controller part based on the input made to the input part 6. Each of the screen-side indicators 13B of this embodiment emits light in a color based on the control of the controller part, and displays the number (quantity) of the medicine to be placed into the receiving part 12 corresponding to the screen-side indicator 13B.

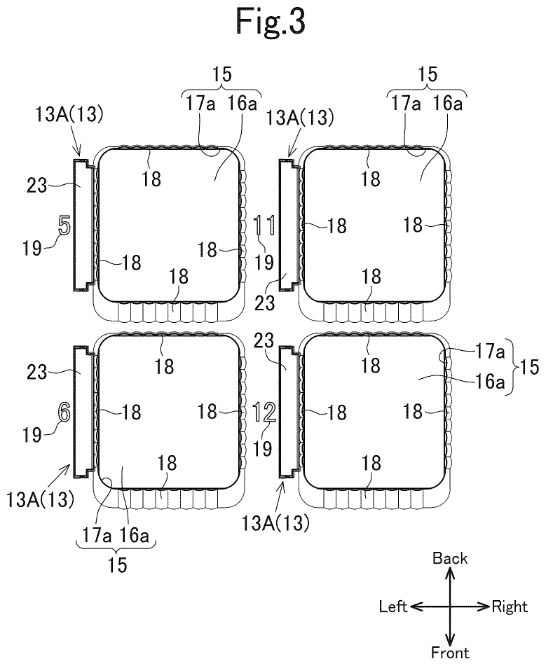

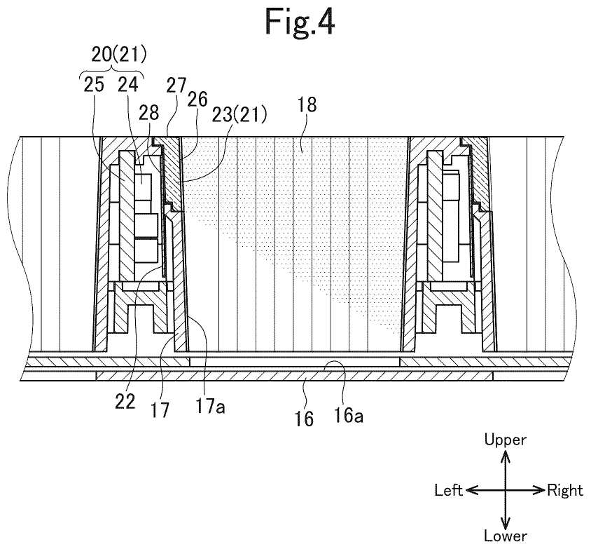

As shown in FIG. 3 and FIG. 4, each of the receiving body-side indicators 13A is disposed in a space inside the side wall 17. Each of the receiving body-side indicators 13A is a portion configured to be capable of projecting light to the inner wall surface 15 of the receiving part 12. Further, the receiving body-side indicators 13A are disposed to correspond to the respective receiving parts 12. Each of the receiving body-side indicators 13A of this embodiment includes a light projector 21 having a light source 20 and configured to project light to the inner wall surface 15 of the receiving part 12, and an insulating sheet part 22 for protecting the light source 20 from static electricity. The light source 20 of this embodiment is an LED. The receiving body-side indicator 13A of this embodiment is disposed on the left side of each receiving part 12. Further, the receiving body-side indicator 13A of this embodiment is disposed in an upper half area in the vertical direction of the receiving part 12. Such a receiving body-side indicator 13A is configured to allow light in a color selected from a plurality of colors including white to be projected to the inner wall surface 15 of the receiving part 12. Further, each of the plurality of receiving body-side indicators 13A projects light to the inner wall surface 15 of the receiving part 12 according to the control of the controller part.

The light projector 21 is a portion for illuminating the inner wall surface 15. Specifically, the light projector 21 includes the light source 20 that emits light to illuminate the inner wall surface 15, and a light transmissive part 23 that transmits the light emitted by the light source 20. The light source 20 of this embodiment includes a light emitter body 24 that emits light, and a board 25 having a circuit for allowing the light emitter body 24 to emit light. In this embodiment, the light projector 21 has one board 25 for each row of the receiving parts 12 arranged in the depth direction, and has a plurality of the light emitter bodies 24 arranged on the board 25 to be separated in the depth direction from each other. In this embodiment, the plurality of light emitter bodies 24 are disposed on each board 25, but each of the plurality of light emitter bodies 24 is configured to project, to the inner wall surface 15, light in the same color as or a different color from the color of another light emitter body 24 disposed on the same board 25. That is, the light emitter body 24 can emit light independently of another light emitter body 24 on the same board 25.

The light source 20 is a portion that emits light toward the inner wall surface 15. Further, the light source 20 is disposed to emit light at least to the back side surface of the inner wall surface 15. In this embodiment, the light source 20 is configured to emit light to three side surfaces of the inner wall surface 15 except the surface in which the light projector 21 is located. The side surface of the inner wall surface 15 in which the light source 20 is located is indirectly illuminated by reflected light from the other surfaces. Further, the light source 20 is located to emit light from a lateral side to the back side surface of the inner wall surface 15. In this embodiment, the light source 20 is configured to emit light from the left side of the back side surface of the inner wall surface 15. That is, the back side surface of the inner wall surface 15 is irradiated with light from the lateral side (i.e., left side). The back side surface of the inner wall surface 15 refers to a surface located farthest from the operator standing on the front side of the medicine packaging apparatus 1 when the operator manually distributes the medicine to the receiving parts 12. In this embodiment, the back side surface of the inner wall surface 15 refers to a surface of the inner wall surface 15 closest to the housing 5 when the receiving body 11 is at the projecting position. The light source 20 of this embodiment is configured to be capable of projecting colored light and white light to the inner wall surface 15 of the receiving part 12. In this embodiment, the light source 20 is located in the upper half area in the vertical direction of the receiving part 12.

The light transmissive part 23 is a plate-like portion that transmits light. Further, the light transmissive part 23 is a plate-like member configured to scatter transmitted light. The light transmissive part 23 of this embodiment is a milky white plate-like member. The light transmissive part 23 is located to serve as a part of the side wall 17. Specifically, the side wall 17 has a cutout to allow the inside and the outside of the side wall 17 to communicate with each other, and the light transmissive part 23 is a plate-like member fitted into the cutout formed in the side wall 17.

The light transmissive part 23 includes a first surface 26 serving as a part of the side surface 17a, a second surface 27 continuous with the first surface 26 and serving as a part of the upper end surface surrounding the receiving area S1, and a light-source-opposed surface 28 opposed to the light source 20. The first surface 26 is the opposite surface to the light-source-opposed surface 28. Further, the first surface 26 is a surface to be so called substantially flush with the inner surface of the side wall 17, and the second surface 27 is a surface to be so called substantially flush with the upper end surface of the receiving part 12. When the light-source-opposed surface 28 is irradiated with light emitted by the light source 20, the light transmissive part 23 allows transmitted light to be projected to the inner wall surface 15 through the first surface 26 and to be projected upward through the second surface 27. The light transmissive part 23 of this embodiment is configured to scatter the light irradiated to the light-source-opposed surface 28 to project part of the light upward through the second surface 27. In this embodiment, the second surface 27 and the identification mark 19 corresponding to one receiving part 12 are disposed adjacent to each other.

The insulating sheet part 22 is a sheet-like portion made of an insulator capable of transmitting light. The insulating sheet part 22 is a sheet-like portion disposed between the light transmissive part 23 and the light source 20. The insulating sheet part 22 of this embodiment is a transparent sheet. The insulating sheet part 22 of this embodiment provides insulation between the inside of the receiving area S1 and the light source 20. Since the light transmissive part 23 of this embodiment is fitted into the cutout formed in the side wall 17, there can be a case where a gap is formed between the side wall 17 and the light transmissive part 23. In this embodiment, however, the insulating sheet disposed to provide insulation between the receiving area S1 and the light source 20 can suppress static electricity from being discharged from an object inside the receiving area S1 (e.g., the operator's hand) to the light source 20 through the gap between the side wall 17 and the light transmissive part 23. This configuration can suppress damage to the light source 20 by static electricity.

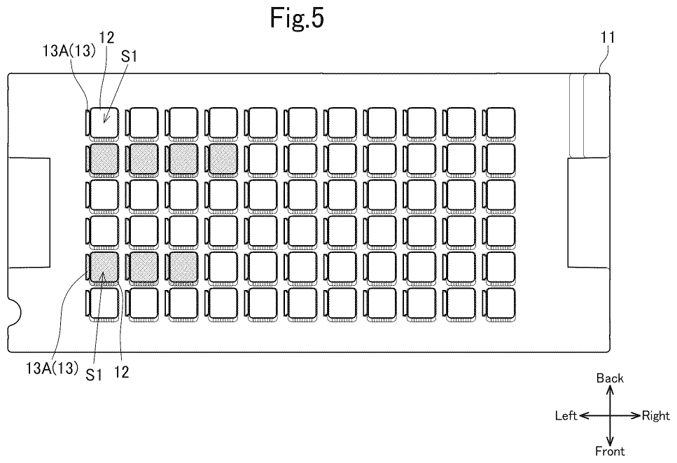

As shown in FIG. 4 and FIG. 5, the light projector 21 projects light upward through the inner wall surface 15 of the receiving part 12 and the upper end surface of the receiving part 12. Further, light emitted by the light source 20 is transmitted through the light transmissive part 23 and projected to the inner wall surface 15 through the first surface 26. Thus, the light projector 21 illuminates the receiving part 12 itself. The light projector 21 provided at a position close to the back side surface of the inner wall surface 15 reliably illuminates the back side surface. Since the inner wall surface 15 has the unevenness 18 (grooves) extending in the vertical direction, shadows extending in the vertical direction are casted on the back side surface when light is projected to the inner wall surface 15. The striped shadows thus casted on the inner wall surface 15 illuminated by the light projector 21 can facilitate placement of the medicine into the receiving part 12 with the illuminated inner wall surface 15. Further, light emitted by the light source 20 is transmitted through the light transmissive part 23 to be projected upward through the second surface 27.

The destaticizer is disposed inside the housing 5, and is configured to be capable of eliminating static electricity from the medicine in the receiving part 12. In this embodiment, the destaticizer is disposed to focus on eliminating static electricity from the medicine in the receiving body 11 (each receiving part 12), rather than eliminating static electricity from the receiving body 11 itself. The destaticizer generates ions to eliminate static electricity from the medicine in the receiving part 12. That is, the destaticizer is configured to be capable of contactlessly eliminating static electricity from the medicine in the receiving part 12. Specifically, the destaticizer applies the ions to a surface of the medicine to eliminate static electricity from the surface of the medicine. That is, the destaticizer of this embodiment is a so-called ionizer.

The input part 6 is a portion to which information on the medicine to be packaged can be input. Specifically, information for determining which medicine should be placed in each receiving part 12 can be input to the input part 6. In this embodiment, prescription information is input to the input part 6. The prescription information includes an information item (types and quantities) relating to a combination of the medicine to be packaged in each package, and an information item relating to the timing of taking the medicine to be received in the receiving body 11. That is, the prescription information includes information on which medicine should be packaged. The input part 6 is formed of, for example, a touch panel. The input part 6 can also be configured to allow information to be input through communication with an external terminal (e.g., controller or dispensing system installed in a pharmacy).

As shown in the display screen 7 of FIG. 7, information for operating the manual medicine distributing apparatus 3 can be input to the input part 6 of this embodiment. Specifically, the input part 6 includes a placement completion button 61 for inputting information that the medicine has been placed into the receiving parts 12, a mode switch button 62 for switching a mode of indication of the indicators 13, and a medicine selection button 63 for inputting information on the medicine to be placed. The placement completion button 61, the mode switch button 62, and the medicine selection button 63 of this embodiment are virtual buttons displayed on the display screen 7. The mode switch button 62 and the medicine selection button 63 are virtual radio buttons, and the button input immediately before is displayed by being colored (in the drawings, the colored portions are shown by halftone dots). The mode switch button 62 includes: a first mode button 621 (i.e., button reading “Per Dose” in FIG. 7) for switching to a first mode in which the indicators 13 are color-coded for indication according to each timing of taking the medicine to be placed into the respective receiving parts 12; a second mode button 622 (i.e., button reading “Per Combination” in FIG. 7) for switching to a second mode in which the indicators 13 are color-coded for indication according to each combination of the medicine to be placed into the respective receiving parts 12; and a third mode button 623 (i.e., button reading “White” in FIG. 7) for switching to a third mode in which the receiving body-side indicators 13A project white light to the inner wall surfaces 15 of the respective receiving parts 12 into which the medicine is to be placed. The mode switch button 62 further includes: an individual indication button 624 for switching to an individual indication mode in which the indicators 13 indicate those receiving parts 12 into which the medicine is to be placed according to each type of the medicine to be placed into the respective receiving parts 12; and a prescription indication button 625 for switching to a prescription indication mode in which the indicators 13 indicate those receiving parts 12 into which the medicine is to be placed according to each prescription. In this embodiment, the combination of the medicine refers to a combination identified based on the information item relating to the types and quantities of the medicine, and combinations are treated as the same combinations if the types and quantities per type of the medicine are completely identical to each other between the combinations while combinations are treated as different combinations if any of the types and quantities per type of the medicine is different from each other between the combinations. The medicine selection button 63 is a button corresponding to each of the types of medicine to be placed. The medicine selection button 63 of this embodiment is a button reading the information item for identifying the medicine to be placed (e.g., name) and the information item on the quantity of the medicine to be placed (e.g., dose for each timing of taking the medicine).

The controller part controls the entire medicine packaging apparatus 1. The controller part controls the entire medicine packaging apparatus 1 based on the information input to the input part 6. Specifically, the controller part controls the automatic feeding apparatus 2 based on the prescription information input to the input part 6 to feed the medicine to be packaged to the packaging part 4. When, for example, the medicine to be packaged is not stored in the automatic feeding apparatus 2, the controller part controls the manual medicine distributing apparatus 3, determining that the medicine needs to be manually distributed.

The controller part controls the indicators 13 based on the prescription information input to the input part 6, and the information input to the mode switch button 62 and the medicine selection button 63. Specifically, the controller part controls the screen-side indicators 13B and the receiving body-side indicators 13A for indication of both the screen-side indicators 13B and the receiving body-side indicators 13A corresponding to the receiving body 11 into which the medicine is to be placed. A description on how the indicators 13 are specifically indicated will be given later.

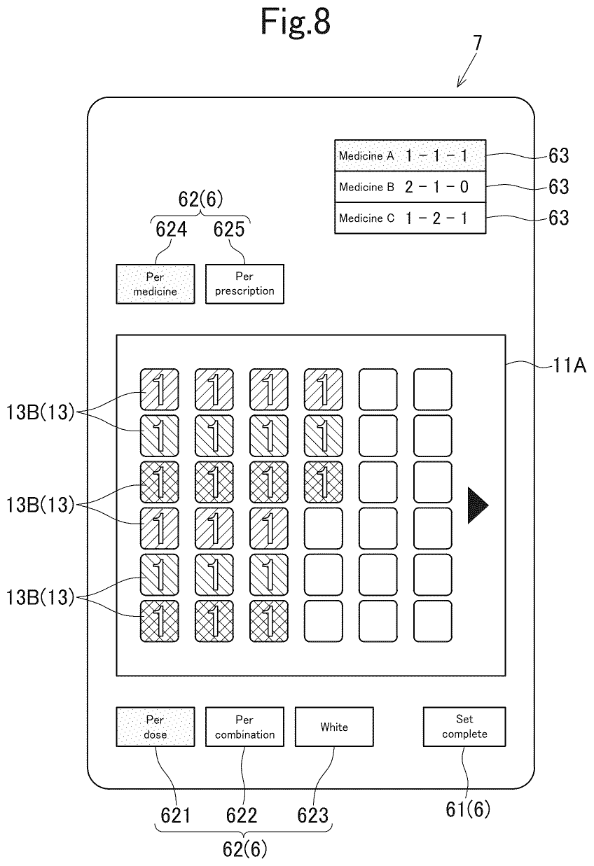

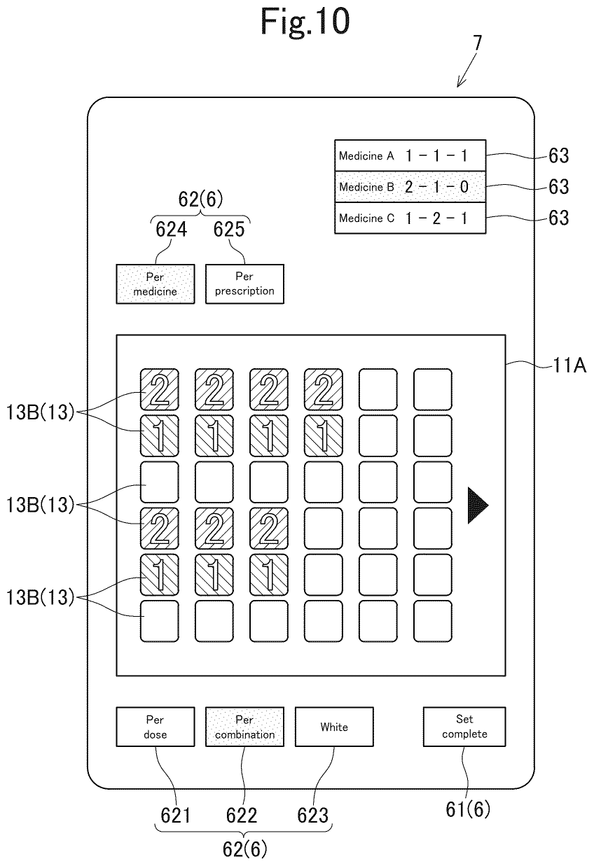

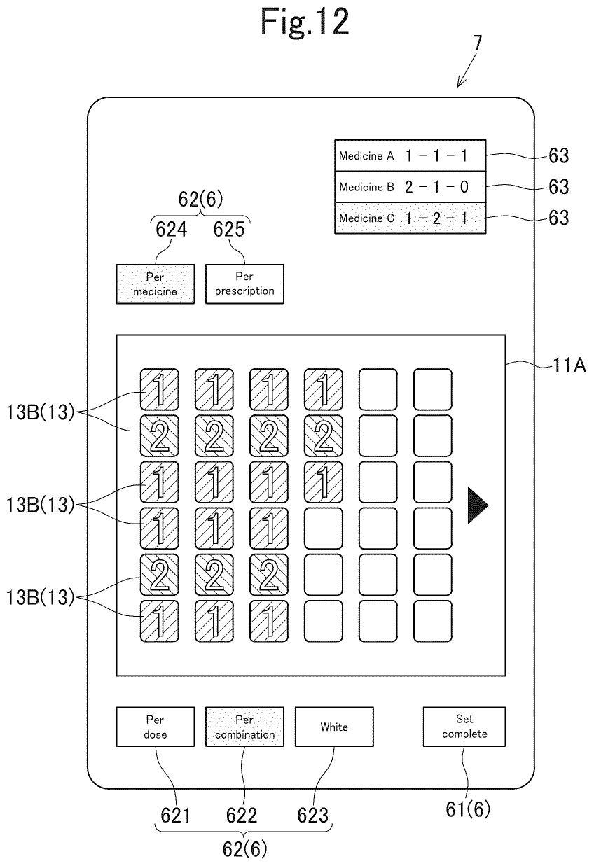

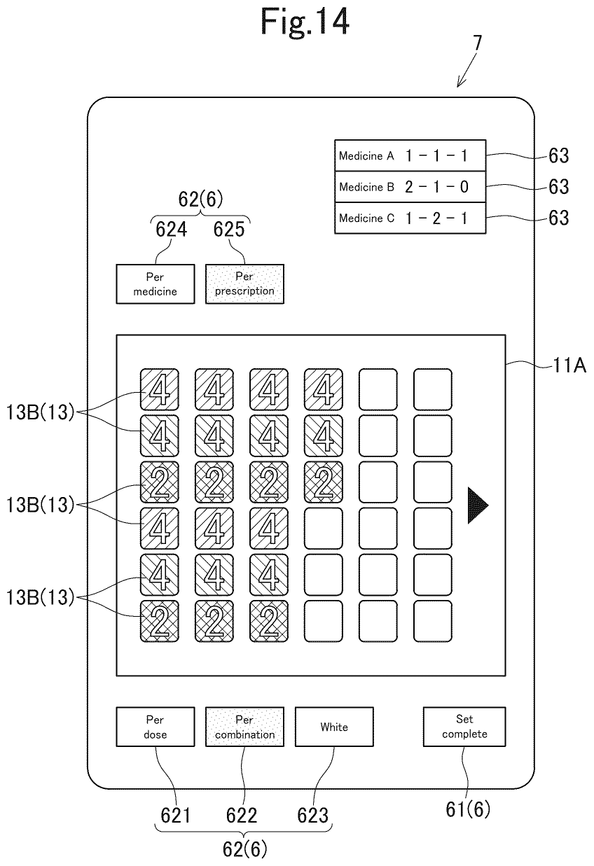

As shown in FIG. 7, FIG. 8, FIG. 10, FIG. 12, and FIG. 14, the display screen 7 is a screen that displays the status of the device and information for input by the operator to the input part 6. Specifically, displayed on the display screen 7 are: the placement completion button 61, the mode switch button 62, and the medicine selection button 63, which are the input part 6; the virtual receiving body 11A; and the screen-side indicators 13B. In this embodiment, only a portion in the width direction (i.e., direction orthogonal to the vertical direction and the depth direction) of the virtual receiving body 11A is displayed, and an input (i.e., scrolling operation) to the input part 6 enables another portion in the width direction of the virtual receiving body 11A to be displayed.

Next, a description will be given on an operation of the manual medicine distributing apparatus 3. Hereinafter, a description will be given on the case where three types of medicine, namely: medicine A, medicine B, and medicine C, are to be manually distributed, and “3 divided doses” of medicine, which means that the medicine is taken three times a day (i.e., morning, noon, and evening), are to be manually distributed for seven days (i.e., the total of 21 packages). The description will be further given on the case where one tablet each of the medicine A is taken in the morning, the noon, and the evening; two tablets of the medicine B in the morning and one in the noon; and one tablet of the medicine C in the morning, two in the noon, and one in the evening.

First, when the medicine needs to be manually distributed, the controller part moves the receiving body 11 to the projecting position. In this embodiment, the controller part determines whether or not manual distribution is required based on, for example, the prescription information transmitted from an external host computer to the medicine packaging apparatus 1 and input to the input part 6, and when it determines that manual distribution is required, the controller part moves the receiving body 11 to the projecting position. Specifically, the controller part determines that manual distribution is required when the medicine included in the prescription information is not stored in the cassette of the automatic feeding apparatus 2. In this embodiment, the controller part moves the receiving body 11 to the projecting position, determining that manual distribution is required for the medicine A, the medicine B, and the medicine C.

The controller part then determines which receiving part 12 the manually distributed medicine should be placed into, based on the prescription information. Specifically, the controller part determines that the receiving part 12 corresponding to an order of packaging the manually distributed medicine is the receiving part 12 into which the manually distributed medicine should be placed. In this embodiment, a description will be given on so-called repeated packaging in which doses for the morning, the noon, and the evening are repeatedly packaged. That is, among rows each formed of the receiving parts 12 of this embodiment arranged in the depth direction of the receiving body 11, the first and fourth receiving parts 12 from the back side are the receiving parts 12 into which morning doses of the medicine are placed, the second and fifth are the receiving parts 12 into which noon doses are placed, and the third and sixth are the receiving parts 12 into which evening doses are placed. In addition, continuous packaging in which the doses of the medicine for the same timing are continuously packaged (e.g., morning, morning, morning . . . , noon, noon, noon . . . , evening, evening, evening . . . ) can also be employed. In such a case, the morning doses of the medicine are placed into those receiving parts 12 corresponding to the first to seventh packages, the noon doses of the medicine are placed into those receiving parts 12 corresponding to the eighth to 14th packages, and the evening doses of the medicine are placed into those receiving parts 12 corresponding to the 15th to 21st packages.

When the controller part determines that some medicine needs to be manually distributed, the controller part moves the receiving body 11 to the projecting position and controls those indicators 13 corresponding to the receiving parts 12 into which the medicine should be manually distributed from the state of determining the necessity of manual distribution based on the prescription information, to shift to a position indication mode in which the indicators 13 are color-coded for indication based on the prescription information and the input to the input part 6. Here, the controller part controls to allow the receiving body-side indicator 13A and the screen-side indicator 13B corresponding to the same receiving part 12 to be indicated in the same color. The controller part also determines a mode of indication of the indicator 13 based on the input made to the mode switch button 62 of the input part 6, and controls the indicator 13 to be indicated in the mode of indication based on the prescription information. Specifically, the controller part determines whether the setting in the position indication mode is in the individual indication mode or in the prescription indication mode based on which one of the individual indication button 624 and the prescription indication button 625 is input, and determines whether the setting is in the first mode or in the second mode based on which one of the first mode button 621 and the second mode button 622 is input. In this embodiment, a description will be given on the case where the first mode of the individual indication mode is selected as the initial state (i.e., the case where no input is made to the mode switch button 62 of the input part 6). The configuration is however not limited thereto, and can be such that another mode is selected or the mode to be selected in the initial state is preset by the operator. The description begins with a flow of manually distributing the medicine in the individual indication mode.

In the individual indication mode, the indicators 13 are controlled by the controller part to be color-coded for indication according to each type of the medicine to be placed. Specifically, the indicators 13 for the first mode in the individual indication mode are color-coded for indication according to each timing of taking the medicine to be placed into the corresponding receiving parts 12, and the indicators 13 for the second mode in the individual indication mode are color-coded for indication according to each quantity of the medicine to be placed into the corresponding receiving parts 12. In the individual indication mode of this embodiment, those indicators 13 corresponding to the receiving parts 12 into which 0 tablet of the medicine should be placed (i.e., the receiving parts 12 into which no medicine should be placed) are controlled not to be indicated. In the individual indication mode of this embodiment, the input part 6 is configured to indicate the type of the medicine selected in the medicine selection button 63, and after the manual distribution of the medicine is completed, the state shifts to the indication of the type of the next medicine when the operator selects the medicine to be next placed with the medicine selection button 63.

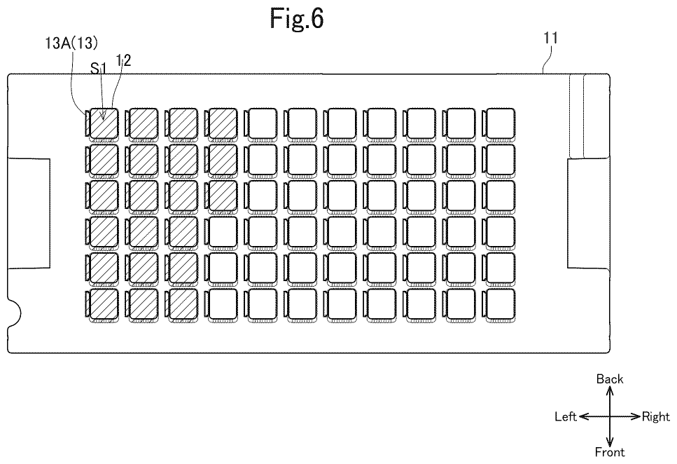

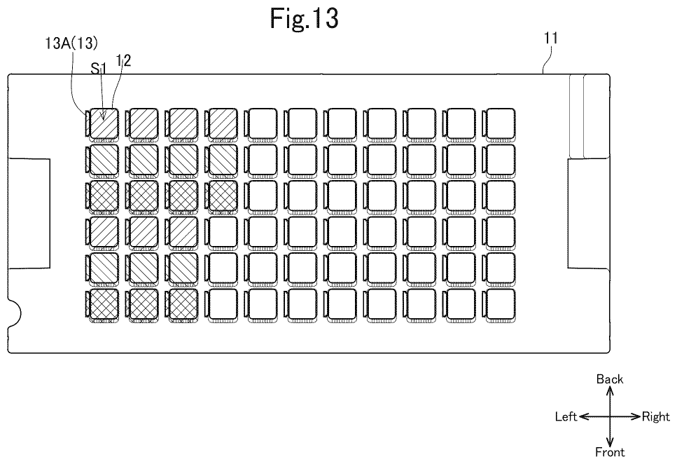

For the convenience of description, the description begins with the second mode in the individual indication mode. As shown in FIG. 6 and FIG. 7, in the second mode when the medicine A (one tablet each is to be taken in the morning, the noon, and the evening) is placed in the individual indication mode, the same type of the medicine in the same quantity is placed into each of those receiving parts 12 corresponding to the first to 21st packages; thus, all of the corresponding indicators 13 are controlled to be indicated in the same color. Further, as shown in FIG. 8, in the first mode when the medicine A (one tablet each is to be taken in the morning, the noon, and the evening) is placed in the individual indication mode, the indicators 13 respectively corresponding to: those receiving parts 12 into which the morning doses of the medicine are to be placed (i.e., first and fourth receiving parts 12 from the back side of the rows each formed of the receiving parts 12 arranged in the depth direction of the receiving body 11); those receiving parts 12 into which the noon doses of the medicine are to be placed (i.e., second and fifth receiving parts 12 from the back side of the rows each formed of the receiving parts 12 arranged in the depth direction of the receiving body 11); and those receiving parts 12 into which the evening doses of the medicine are to be placed (i.e., third and sixth receiving parts 12 from the back side of the rows each formed of the receiving parts 12 arranged in the depth direction of the receiving body 11) are controlled to be indicated in different colors (the indication of the receiving body-side indicators 13A are as in the state shown in FIG. 13 in which an indication example in another mode is shown). At this time, each of the screen-side indicators 13B is indicated with the number of tablets to be placed into the corresponding receiving part 12. In this embodiment, the screen-side indicator 13B is indicated with a numerical figure as the number of tablets to be placed into the corresponding receiving part 12 virtually shown on the screen-side indicator 13B.

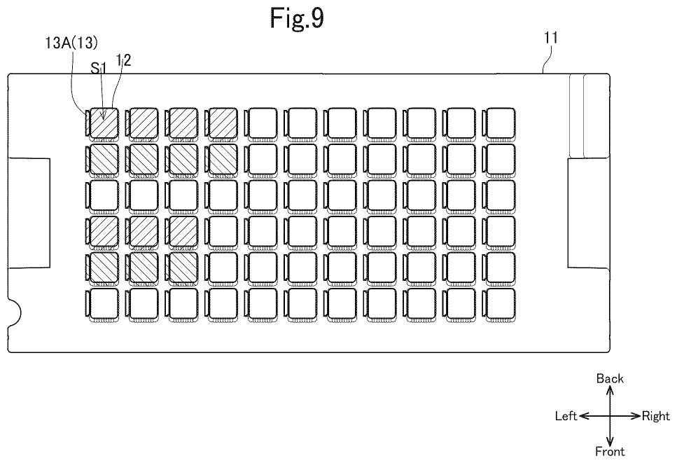

As shown in FIG. 9 and FIG. 10, in the second mode when the medicine B (two tablets are to be taken in the morning, and one in the noon) is placed in the individual indication mode, the receiving parts 12 into which morning doses of the medicine are to be placed differ from the receiving parts 12 into which noon doses of the medicine are to be placed in terms of the quantity of the medicine to be placed thereinto; thus, the indicators 13 corresponding to those receiving parts 12 into which the morning doses of the medicine are to be placed (i.e., first and fourth receiving parts 12 from the back side of the rows each formed of the receiving parts 12 arranged in the depth direction of the receiving body 11) and the indicators 13 corresponding to those receiving parts 12 into which the noon doses of the medicine are to be placed (i.e., second and fifth receiving parts 12 from the back side of the rows each formed of the receiving parts 12 arranged in the depth direction of the receiving body 11) are controlled to be indicated in different colors. Further, since the medicine B should not be placed into those receiving parts 12 into which evening doses of the medicine are to be placed (i.e., third and sixth receiving parts 12 from the back side of the rows each formed of the receiving parts 12 arranged in the depth direction of the receiving body 11), the indicators 13 corresponding to those receiving parts 12 into which the evening doses of the medicine are to be placed are controlled not to be indicated. Specifically, the receiving body-side indicators 13A corresponding to those receiving parts 12 into which no medicine should be placed are blacked out, and the screen-side indicators 13B corresponding to those receiving parts 12 into which no medicine should be placed are indicated in a blank state. In the first mode when the medicine B (to be taken in the morning and the noon) is placed in the individual indication mode, the indicators 13 corresponding to those receiving parts 12 into which the morning doses of the medicine are to be placed (i.e., first and fourth receiving parts 12 from the back side of the rows each formed of the receiving parts 12 arranged in the depth direction of the receiving body 11) and the indicators 13 corresponding to those receiving parts 12 into which the noon doses of the medicine are to be placed (i.e., second and fifth receiving parts 12 from the back side of the rows each formed of the receiving parts 12 arranged in the depth direction of the receiving body 11) are controlled to be indicated in different colors, and the indicators 13 corresponding to those receiving parts 12 into which the evening doses of the medicine are to be placed (i.e., third and sixth receiving parts 12 from the back side of the rows each formed of the receiving parts 12 arranged in the depth direction of the receiving body 11) are controlled not to be indicated. That is, when the medicine B is placed, the indicators 13 are color-coded for indication in the same manner between the first mode and the second mode.

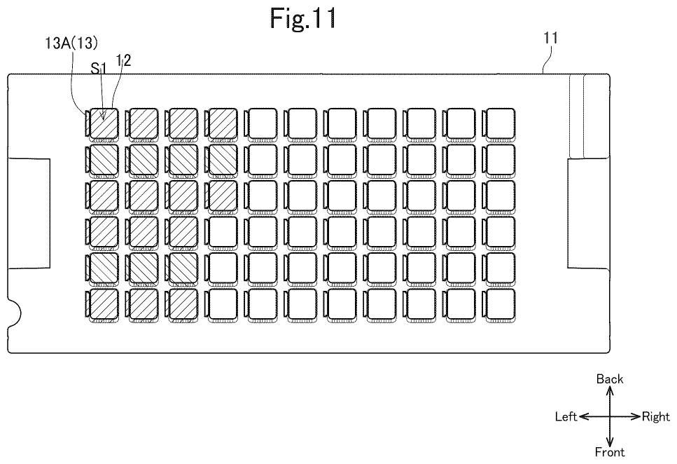

As shown in FIG. 11 and FIG. 12, in the second mode when the medicine C (one tablet to be taken in the morning, two in the noon, and one in the evening) is placed in the individual indication mode, the receiving parts 12 into which morning and evening doses of the medicine are to be placed differ from the receiving parts 12 into which noon doses of the medicine are to be placed in terms of the quantity of the medicine to be placed thereinto; thus, the indicators 13 corresponding to those receiving parts 12 into which the morning doses of the medicine are to be placed (i.e., first and fourth receiving parts 12 from the back side of the rows each formed of the receiving parts 12 arranged in the depth direction of the receiving body 11) and the indicators 13 corresponding to those receiving parts 12 into which the evening doses of the medicine are to be placed (i.e., third and sixth receiving parts 12 from the back side of the rows each formed of the receiving parts 12 arranged in the depth direction of the receiving body 11) are controlled to be indicated in the same color, and the indicators 13 corresponding to those receiving parts 12 into which the noon doses of the medicine are to be placed (i.e., second and fifth receiving parts 12 from the back side of the rows each formed of the receiving parts 12 arranged in the depth direction of the receiving body 11) are controlled to be indicated in a different color. In the first mode when the medicine C (to be taken in the morning, the noon, and the evening) is placed in the individual indication mode, the indicators 13 respectively corresponding to those receiving parts 12 into which the morning doses of the medicine are to be placed (i.e., first and fourth receiving parts 12 from the back side of the rows each formed of the receiving parts 12 arranged in the depth direction of the receiving body 11), corresponding to those receiving parts 12 into which the noon doses of the medicine are to be placed (i.e., second and fifth receiving parts 12 from the back side of the rows each formed of the receiving parts 12 arranged in the depth direction of the receiving body 11), and corresponding to those receiving parts 12 into which the evening doses of the medicine are to be placed (i.e., third and sixth receiving parts 12 from the back side of the rows each formed of the receiving parts 12 arranged in the depth direction of the receiving body 11) are controlled to be indicated in different colors (the indicators 13 are as in the state shown in FIG. 10 and FIG. 13 in which an indication example in another mode is shown).

Next, a description will be given on the prescription indication mode. As shown in FIG. 13 and FIG. 14, the indicators 13 in the prescription indication mode are configured to be color-coded for indication according to each prescription through control by the controller part. That is, in the prescription indication mode, the indicators 13 are controlled to be indicated based on a timing of taking the medicine or a combination of the medicine for all the medicine to be placed during a single manual distribution. In the first mode in the prescription indication mode, the indicators 13 are controlled to be color-coded for indication according to each timing of taking the medicine to be placed into the respective receiving parts 12. Specifically, the indicators 13 corresponding to those receiving parts 12 into which the morning doses of the medicine are to be placed (i.e., first and fourth receiving parts 12 from the back side of the rows each formed of the receiving parts 12 arranged in the depth direction of the receiving body 11), the indicators 13 corresponding to those receiving parts 12 into which the noon doses of the medicine are to be placed (i.e., second and fifth receiving parts 12 from the back side of the rows each formed of the receiving parts 12 arranged in the depth direction of the receiving body 11), and the indicators 13 corresponding to those receiving parts 12 into which the evening doses of the medicine are to be placed (i.e., third and sixth receiving parts 12 from the back side of the rows each formed of the receiving parts 12 arranged in the depth direction of the receiving body 11) are controlled to be respectively indicated in different colors. In the second mode, the indicators 13 are controlled to be color-coded for indication according to each combination of the medicine to be placed into the respective receiving parts 12. Specifically, in the second mode, combinations are treated as the same combinations if the types and quantities per type of the medicine are completely identical to each other between the combination while combinations are treated as different combinations if any of the types and quantities per type of the medicine is different from each other between the combinations. The indicators 13 are controlled to be indicated in the same color if the indicators 13 correspond to those receiving parts 12 into which the same combination of the medicine is to be placed, and are controlled to be indicated in different colors if the indictors 13 correspond to those receiving parts 12 into which different combinations of the medicine are to be placed. In this embodiment, since the combination of the medicine for a morning dose, the combination of the medicine for a noon dose, and the combination of the medicine for an evening dose differ from each other, the indicators 13 corresponding to those receiving parts 12 into which the morning doses of the medicine are to be placed (i.e., first and fourth receiving parts 12 from the back side of the rows each formed of the receiving parts 12 arranged in the depth direction of the receiving body 11), the indicators 13 corresponding to those receiving parts 12 into which the noon doses of the medicine are to be placed (i.e., second and fifth receiving parts 12 from the back side of the rows each formed of the receiving parts 12 arranged in the depth direction of the receiving body 11), and the indicators 13 corresponding to those receiving parts 12 into which the evening doses of the medicine are to be placed (i.e., third and sixth receiving parts 12 from the back side of the rows each formed of the receiving parts 12 arranged in the depth direction of the receiving body 11) are controlled to be respectively indicated in different colors. That is, in the prescription indication mode of this embodiment, the indicators 13 are color-coded for indication in the same manner between the first mode and the second mode.

In each of the above modes, the indictors 13 are indicated to allow the operator to identify whether the indicators 13 are indicated according to the first mode or indicated according to the second mode. The indicators 13 of this embodiment are controlled to light in a specific color in the first mode and to flash in a specific color in the second mode. The configuration is not limited thereto, and employed can be such a configuration that the indicators 13 flash in the first mode and light in the second mode, or that the indicators 13 are not indicated to identify whether they are in the first mode or the second mode. Further, the operator can identify whether the mode is in the first mode or the second mode by checking the state of the mode switch button 62 (colored button) without relying on the indicators 13.

Based on the input made to the input part 6, the controller part shifts a mode from the position indication mode to a check mode during or after the placement of the medicine into the receiving parts 12. The controller part in the check mode controls the light projector 21 of each of the receiving body-side indicators 13A in at least one of the third mode in which the light projector 21 projects white light to the inner wall surface 15 of the receiving part 12 and a fourth mode in which the light projector 21 does not project light to the inner wall surface 15 of the receiving part 12. In this embodiment, the shift from the position indication mode to the check mode is executed when an input is made to switch to the third mode or the fourth mode. Further, when an input is made in the check mode to switch to the first mode or the second mode, the mode shifts from the check mode to the position indication mode. In this embodiment, the input to switch to the first mode refers to an input by tapping the first mode button 621, the input to switch to the second mode refers to an input by tapping the second mode button 622, and the input to switch to the third mode refers to an input by tapping the third mode button 623. Further, the input to switch to the fourth mode refers to an input by tapping the selected button among the first mode button 621, the second mode button 622, and the third mode button 623 once again to thereby cancel the selection. The configuration is not limited thereto, and can be such that the input part 6 includes a fourth mode button for switching to the fourth mode, and the input is deemed to be made to switch to the fourth mode when the fourth mode button is tapped.

In the third mode, white light is projected to the inner wall surface 15 of the receiving part 12. Thus, the color of the medicine or characters engraved or printed on the medicine can be made more visible than in the case where colored light is projected. This configuration enables the medicine placed to be easily checked. When, however, the projected light is reflected on the inner wall surface 15 or the medicine to make the operator feel glaring, the mode can be switched to the fourth mode to thereby suppress the glaring and allow the medicine irradiated not with the projected light but with indoor light to be easily visible. This configuration enables the medicine placed to be easily checked.

When the placement of all the medicine and the operator's checking are completed, the receiving body 11 moves from the projecting position to the housed position. In this embodiment, when the placement completion button 61 on the input part 6 is tapped, the controller part controls to move the receiving body 11 from the projecting position to the housed position. The controller part can also be configured to control the placement completion button 61 to be capable of being tapped only after the check mode is executed, so that the receiving body 11 is moved from the projecting position to the housed position after the check mode is executed. Such control can suppress the receiving body 11 from being moved to the housed position before the operator checks the medicine in the receiving parts 12.

When moved to the housed position, the receiving body 11 sequentially feeds the medicine in the receiving parts 12 to the packaging part 4. Specifically, the receiving body 11 is controlled by the controller part to open the bottom parts 16 of the receiving body 11. The medicine in each of the receiving parts 12 of which the bottom part 16 is opened falls and is fed to the packaging part 4 through the medicine feeding passage.

The manual medicine distributing apparatus 3 configured as above enables the indication of the indicators 13 to be switched between the first mode and the second mode according to, for example, the medicine to be manually distributed or the operator's preference, and thus enables the medicine to be easily placed into the receiving parts 12 by reference to the indication of the indicators 13. This configuration achieves increased usability of the manual medicine distributing apparatus 3.

The manual medicine distributing apparatus 3 enables the indication of the indicators 13 to be switched between the first mode and the second mode according to each type of the medicine, and thus enables the medicine to be easily placed into the receiving parts 12 by reference to the indication of the indicators 13. This configuration achieves increased usability of the manual medicine distributing apparatus 3.

Further, the manual medicine distributing apparatus 3 enables the indication of the indicators 13 to be switched between the first mode and the second mode according to each prescription, and thus enables the medicine to be easily placed into the receiving parts 12 by reference to the indication of the indicators 13. This configuration achieves increased usability of the manual medicine distributing apparatus 3.

The indicators 13 are indicated to allow the operator to identify whether the first mode is selected or the second mode is selected, and thus the operator can easily recognize whether the first mode is selected or the second mode is selected, simply by checking the indicators 13. This configuration achieves increased usability of the manual medicine distributing apparatus 3.

Further, each of the indicators 13 projects light to the inner wall surface 15 of the receiving part 12 to illuminate the receiving part 12 itself with light; how the indicators 13 are indicated and how they correspond to the respective receiving parts 12 are easily identifiable in the first mode and the second mode; and the indicators 13 are switchable from the first mode or the second mode to the third mode in which the indicators 13 project white light to illuminate the receiving parts 12 with white light when the placed medicine is checked. Thus, the color of the medicine and the characters engraved on the medicine can be made more visible. This configuration achieves increased usability of the manual medicine distributing apparatus 3.

Each of the indicators 13 projects light to the inner wall surface 15 of the receiving part 12 to illuminate the receiving part 12 itself with light; how the indicators 13 are indicated and how they correspond to the respective receiving parts 12 are easily identifiable in the first mode and the second mode; and the indicators 13 are switchable from the first mode or the second mode to the fourth mode in which none of the indicators 13 projects white light to the inner wall surfaces 15. Such a configuration can suppress the projected light to the inner wall surfaces 15 from interfering with the operation of checking the placed medicine. This configuration achieves increased usability of the manual medicine distributing apparatus 3.

Further, the configuration that the indication of the indicators 13 is switchable between the individual indication mode and the prescription indication mode according to, for example, the medicine to be manually distributed or the preference of the operator enables the medicine to be easily placed into the receiving parts 12 by reference to the indication of the indicators 13. This configuration achieves increased usability of the manual medicine distributing apparatus 3.

Further, each of the indicators 13 projects light to the inner wall surface 15 of the receiving part 12 to illuminate the receiving part 12 itself with light; how the indicators 13 are indicated and how they correspond to the respective receiving parts 12 are easily identifiable in the first mode and the second mode; and the indicators 13 are switchable between the position indication mode and the check mode. Such a configuration can suppress the color-coded projected light to the inner wall surfaces 15 from interfering with the operation of checking the placed medicine. This configuration achieves increased usability of the manual medicine distributing apparatus 3.

The configuration that the screen-side indicator 13B and the corresponding receiving body-side indicator 13A are indicated in the same color in the first mode or the second mode enables the operator to obtain the same information when he or she refers to the screen-side indicator 13B or the receiving body-side indicator 13A. This configuration achieves increased usability of the manual medicine distributing apparatus 3.

Further, in the check mode, information for switching the indicators 13 between the third mode and the fourth mode can be input to the input part 6, and the controller part switches the indicators 13 between the third mode and the fourth mode based on the input made to the input part 6. Such a configuration enables switching between the state where the receiving body-side indicator 13A (light projector 21) illuminates the inner wall of the receiving part 12 with white light and the state where it does not illuminate the inner wall of the receiving part 12, depending on the medicine placed therein. This configuration enables the medicine in the receiving parts 12 to be easily checked.

In the individual indication mode, the controller part controls the indicators 13 to indicate the type of the selected medicine. Thus, when the operator selects a next medicine after the placement of one medicine is completed, the controller part controls the indicators 13 to indicate the next medicine to be placed. This configuration enables the operation to smoothly shift to the placement of the next medicine after the placement of the one medicine is completed.

Further, the controller part controls the receiving body-side indicators 13A so that only those receiving body-side indicators 13A corresponding to the receiving parts 12 into which the medicine should be placed are indicated (i.e., emit light) while those receiving body-side indicators 13A corresponding to the receiving parts 12 into which no medicine should be placed are not indicated (do not emit light). This configuration can suppress the medicine from being accidentally placed into those receiving parts 12 into which no medicine should be placed.

The light projector 21 projects light to the inner wall surface 15 of each of the receiving part 12s, and thus the inner wall surface 15 of the light projector 21 is illuminated by the light from the light projector 21. This configuration illuminates the receiving part 12 itself (i.e., a recess itself) with light, and thus enables the operator to more easily identify the position at which the medicine should be placed than the configuration that a periphery of the receiving part 12 is illuminated.

Further, the light transmissive part 23 configured to scatter the light emitted by the light source 20 entirely illuminates the inner wall surface 15 with the scattered light emitted by the light source 20. This configuration enables the operator to easily identify the receiving part 12 into which the medicine should be placed. Moreover, the configuration that the light emitted by the light source 20 is scattered allows the operator to feel less glaring than the configuration that the light transmissive part 23 is made to be transparent.

The configuration that the light source 20 is disposed in the upper half area in the vertical direction of the receiving part 12 can suppress the medicine from blocking light after the medicine is placed in the receiving part 12. The configuration that the first surface 26 is disposed on an upper part of the side surface 17a allows the first surface 26 to be hardly hidden by the medicine in the receiving part 12, and thus light can be reliably projected to the inner wall surface 15.

Further, the configuration that the identification mark 19 is disposed for identifying each corresponding receiving part 12 on the upper end surface of the receiving part 12 and that the second surface 27 is disposed adjacent to the identification mark 19 makes identifiable the receiving part 12 into which the medicine should be placed, using both the identification mark 19 and light.

In addition, the configuration that the identification mark 19 and the second surface 27 that correspond to each receiving part 12 are disposed adjacent to each other enables the operator to intuitively recognize the identification mark 19 indicating the receiving part 12 into which the medicine should be placed.

Further, the configuration that the first surface 26 is disposed to be substantially flush with the inner surface of the side wall 17 hardly causes the light transmissive part 23 to block the medicine from being placed into the receiving part 12, and can suppress the receiving capacity of the receiving area S1 from decreasing.

Hereinbefore, one embodiment of the present invention has been described by way of an example. However, the present invention is not limited to this embodiment, and various modifications can be made without departing from the gist of the present invention.

The manual medicine distributing apparatus 3 has been described by taking, for example, the case of being configured as part of the medicine packaging apparatus 1 capable of packaging medicine (tablets and capsules), without limitation thereto. For example, the manual medicine distributing apparatus 3 can be configured integrally with the medicine packaging apparatus 1 capable of packaging both the medicine (tablets and capsules) and powder medicine, or can be configured as a medicine dispensing machine (i.e., an apparatus not designed to package medicine on its own) for feeding medicine to a device other than the medicine packaging apparatus 1.

The light projector 21 has been described by taking, for example, the case of being disposed inside the receiving body 11, without limitation thereto. The configuration can also be such that the light projector 21 is disposed above the receiving body 11 to project light from above to the inner wall surface 15.

Further, the light projector 21 has been described by taking, for example, the case of being configured to project light in single color to illuminate the inner wall surface 15, without limitation thereto. For example, the configuration can also be such that the light projector 21 indicates, along with the single-colored light, a symbol such as a numerical figure or a letter in a color different from the single color.

Further, the receiving body-side indicator 13A has been described by taking, for example, the case of including the light projector 21 configured to project light to the inner wall surface 15 of the receiving part 12, without limitation thereto. For example, the configuration can also be such that the receiving body-side indicator 13A is configured as a light-emitting body disposed on an upper end surface surrounding the receiving part 12, and the light-emitting body emits light only upward from the receiving body 11.

The indicator 13 has been described by taking, for example, the case of including both the receiving body-side indicator 13A and the screen-side indicator 13B, without limitation thereto. The configuration can also be such that the indicator 13 includes only either of them.

The description has been given on the case where the mode shifts to the check mode after the placement of all medicine is completed, without limitation thereto. For example, the configuration can be such that the individual indication mode shifts to the check mode every time the placement of one type of medicine is completed. In the above configuration, the controller part can be configured such that the receiving body-side indicator 13A (light projector 21) corresponding to the receiving part 12 into which one type of medicine that should have been placed immediately before is to be placed projects light to the inner wall surface 15. Such a configuration that those receiving parts 12 into which the medicine should have been placed are identifiable during the checking operation enables easy identification if the medicine is placed into those receiving parts 12 in which no medicine should be placed.

Further, the configuration can be such that, if the number of combinations of the medicine or the number of timings of taking the medicine exceeds the number of colors available for the color-coded indication, those receiving parts 12 for different combinations of the medicine or for different timings of taking the medicine can possibly be indicated in the same color. In such a case, it is preferable that the receiving parts 12 indicated even in the same color be still distinguishable by, for example, changing a flashing speed or a flashing pattern.

Further, the light transmissive part 23 has been described by taking, for example, the case of being milky white in color, without limitation thereto, and can employ various configurations capable of scattering light emitted by the light source 20. The light transmissive part 23 can also be configured not to scatter light emitted by the light source 20, such as being configured to be colorless and transparent.

The description has been given on the case where the light transmissive part 23 and the receiving body 11 are provided separately from each other, without limitation thereto. The function to pass and scatter light can be imparted to the receiving body 11 itself.

Further, the unevenness 18 has been described by taking, for example, the case of being the grooves extending in the vertical direction, without limitation thereto, and can be configured in various shapes. For example, when the unevenness 18 is formed to have an arrow shape, an arrow-shaped shadow can be casted by projecting light to prompt the operator to place the medicine.

The display screen 7 has been described by taking, for example, the case of being disposed on the medicine packaging apparatus 1, without limitation thereto. For example, the display screen 7 can be configured as an external monitor capable of communicating with the controller part of the manual medicine distributing apparatus 3.

Further, the controller part has been described by taking, for example, the case of controlling the indicators 13 to indicate the selected medicine in the individual indication mode, without limitation thereto. For example, the configuration can also be such that the controller part controls the display screen 7 to display medicine to be placed, and controls the indicators 13 to indicate the medicine to be placed; and that the controller part controls the display screen 7 to display medicine to be next placed after an input is received that the placement of the medicine to be placed is completed, and controls the indicators 13 to indicate the medicine to be next placed. Such a configuration can reduce the operator's time and effort for selecting the medicine to be placed.

A summary of this embodiment will be described below.
(1) A manual medicine distributing apparatus of this embodiment is a manual medicine distributing apparatus including a receiving body including a plurality of receiving parts in which medicine can be received, the plurality of receiving parts being open upward and configured to allow an operator to manually place the medicine thereinto from above, the manual medicine distributing apparatus including: a plurality of indicators disposed to correspond respectively to the plurality of receiving parts for color-coded indication of those receiving parts into which the medicine should be placed; a controller part configured to control the plurality of indicators; and an input part for receiving an external input, in which the controller part is configured to control indicators of some or all of those receiving parts into which the medicine should be placed out of the plurality of receiving parts to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription input to the input part, and configured to switch between the first mode and the second mode based on an input by the operator to the input part.

Such a configuration enables the indication of the indicators to be switched between the first mode and the second mode according to, for example, the medicine to be manually distributed or the preference of the operator, and thus enables the medicine to be easily placed into the receiving parts by reference to the indication of the indicators. This configuration achieves increased usability of the manual medicine distributing apparatus.
(2) The manual medicine distributing apparatus according to (1), in which the controller part is configured to control the indicators of some or all of those receiving parts into which the medicine should be placed out of the plurality of receiving parts to be indicated for each type of the medicine, in any one of the first mode in which the indicators are color-coded for indication according to each timing of taking each medicine and a second mode in which the indicators are color-coded for indication according to each quantity of the medicine to be placed into the receiving parts, based on the prescription information on the prescription input to the input part, and configured to switch between the first mode and the second mode based on the input by the operator to the input part.

Such a configuration enables the indication of the indicators to be switched between the first mode and the second mode according to each type of the medicine, and thus enables the medicine to be easily placed into the receiving parts by reference to the indication of the indicators. This configuration achieves increased usability of the manual medicine distributing apparatus.
(3) The manual medicine distributing apparatus according to (1), in which the controller part is configured to control indicators of some or all of those receiving parts into which the medicine should be placed out of the plurality of receiving parts to be indicated for each prescription, in any one of the first mode in which the indicators are color-coded for indication according to each timing of taking each medicine and a second mode in which the indicators are color-coded for indication according to each combination of a type and a quantity of the medicine to be placed into the receiving parts, based on the prescription information on the prescription input to the input part, and configured to switch between the first mode and the second mode based on the input by the operator to the input part.

Such a configuration enables the indication of the indicators to be switched between the first mode and the second mode according to each prescription, and thus enables the medicine to be easily placed into the receiving parts by reference to the indication of the indicators. This configuration achieves increased usability of the manual medicine distributing apparatus.
(4) The manual medicine distributing apparatus according to any one of (1) to (3), in which the controller part controls the indicators to indicate whether the indication is in the first mode or in the second mode in a manner identifiable to the operator.

Such a configuration enables the indicators to be indicated whether the indication is in the first mode or in the second mode in a manner identifiable to the operator, and thus enables the operator to recognize whether the indication is in the first mode or in the second mode simply by checking the indicators. This configuration achieves increased usability of the manual medicine distributing apparatus.
(5) The manual medicine distributing apparatus according to any one of (1) to (4), in which the plurality of indicators each include a light projector configured to project light to an inner wall surface of a corresponding one of the plurality of receiving parts, the light projector is capable of projecting light in a color selected from a plurality of colors including at least white to the inner wall surface, and the controller part can switch from the first mode or the second mode to a third mode in which the light projector projects white light to the inner wall surface.

According to such a configuration, each of the indicators projects light to the inner wall surface of the receiving part to illuminate the receiving part itself with light; how the indicators are indicated and how they correspond to the respective receiving parts are easily identifiable in the first mode and the second mode; and the indicators are switchable from the first mode or the second mode to the third mode in which the indicators project white light to illuminate the receiving parts with white light when the placed medicine is checked. Thus, the color of the medicine and the characters engraved on the medicine can be made more visible. This configuration achieves increased usability of the manual medicine distributing apparatus.
(6) The manual medicine distributing apparatus according to any one of (1) to (5), in which the plurality of indicators each include a light projector configured to project light to an inner wall surface of a corresponding one of the plurality of receiving parts, the light projector can project light in a color selected from a plurality of colors to the inner wall surface, and the controller part can switch from the first mode to the second mode to a fourth mode in which the light projector projects no light to the inner wall surface.

According to such a configuration, each of the indicators projects light to the inner wall surface of the receiving part to illuminate the receiving part itself with light; how the indicators are indicated and how they correspond to the respective receiving parts are easily identifiable in the first mode and the second mode; and the indicators are switchable from the first mode or the second mode to the fourth mode in which none of the indicators projects white light to the inner wall surfaces. Such a configuration can suppress the projected light to the inner wall surfaces from interfering with the operation of checking the placed medicine. This configuration achieves increased usability of the manual medicine distributing apparatus.
(7) The manual medicine distributing apparatus according to any one of (1) to (6), in which the controller part is configured to switch between: an individual indication mode in which the indicators of some or all of those receiving parts into which the medicine should be placed out of the plurality of receiving parts are controlled to be indicated for each type of the medicine, in any one of the first mode in which the indicators are color-coded for indication according to each timing of taking each medicine and the second mode in which the indicators are color-coded for indication according to each quantity of the medicine to be placed into the receiving parts, based on the prescription information on the prescription input to the input part; and a prescription indication mode in which the indicators of some or all of those receiving parts into which the medicine should be placed out of the plurality of receiving parts are controlled to be indicated for each prescription, in any one of the first mode in which the indicators are color-coded for indication according to each timing of taking each medicine and the second mode in which the indicators are color-coded for indication according to each combination of a type and a quantity of the medicine to be placed into the receiving parts, based on the prescription information on the prescription input to the input part, based on the input by the operator to the input part.

Such a configuration enables the indication of the indicators to be switched between the individual indication mode and the prescription indication mode according to, for example, the medicine to be manually distributed or the preference of the operator, and thus enables the medicine to be easily placed into the receiving parts by reference to the indication of the indicators. This configuration achieves increased usability of the manual medicine distributing apparatus.
(8) A manual medicine distributing apparatus of this embodiment is a manual medicine distributing apparatus including a receiving body including a plurality of receiving parts in which medicine can be received, the plurality of receiving parts being open upward and configured to allow an operator to manually place the medicine thereinto from above, the manual medicine distributing apparatus including:
a plurality of indicators disposed to correspond respectively to the plurality of receiving parts for color-coded indication of those receiving parts into which the medicine should be placed; a controller part configured to control the plurality of indicators; and an input part for receiving an external input, in which the plurality of indicators each include a light projector configured to project light to an inner wall surface of a corresponding one of the plurality of receiving parts, the light projector is capable of projecting light in a color selected from a plurality of colors including at least white to the inner wall surface, and the controller part is configured to switch between: a position indication mode in which indicators of some or all of those receiving parts into which the medicine should be placed out of the plurality of receiving parts to are controlled to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription input to the input part; and a check mode in which the indicators are controlled in at least one of a third mode in which the light projector projects white light to the inner wall surface and a fourth mode in which the light projector projects no light to the inner wall surface, based on an input by the operator to the input part.

According to such a configuration, each of the indicators projects light to the inner wall surface of the receiving part to illuminate the receiving part itself with light; how the indicators are indicated and how they correspond to the respective receiving parts are easily identifiable in the first mode and the second mode; and the indicators are switchable between the position indication mode and the check mode. Such a configuration can suppress the color-coded projected light to the inner wall surfaces from interfering with the operation of checking the placed medicine. This configuration achieves increased usability of the manual medicine distributing apparatus.
(9) The manual medicine distributing apparatus according to any one of (1) to (8), including a display screen configured to virtually display at least the receiving body, in which the plurality of indicators include: receiving body-side indicators disposed on the receiving body; and screen-side indicators disposed on the receiving body virtually displayed on the display screen, and the controller part controls each of the receiving body-side indicators and each of the screen-side indicators corresponding to the receiving body-side indicator to be indicated in the same color in the first mode or the second mode.

Such a configuration that the screen-side indicator and the receiving body-side indicator are indicated in the same color in the first mode or the second mode enables the operator to obtain the same information when he or she refers to the screen-side indicator or the receiving body-side indicator. This configuration achieves increased usability of the manual medicine distributing apparatus.

### REFERENCE SIGNS LIST

1: Medicine packaging apparatus
2: Automatic feeding apparatus
3: Manual medicine distributing apparatus
4: Packaging part
5: Housing
6: Input part
7: Display screen
11: Receiving body
12: Receiving part
13: Indicator
13A: Receiving body-side indicator
13B: Screen-side indicator
15: Inner wall surface
16: Bottom part
16a: Bottom surface
17: Side wall
17a: Side surface
18: Unevenness
19: Identification mark
20: Light source
21: Light projector
22: Insulating sheet part
23: Light transmissive part
24: Light emitter body
25: Board
26: First surface
27: Second surface
28: Light-source-opposed surface
61: Placement completion button
62: Mode switch button
621: First mode button
622: Second mode button
623: Third mode button
624: Individual indication button
625: Prescription indication button
63: Medicine selection button
S1: Receiving area

1. A manual medicine distributing apparatus comprising a receiving body comprising a plurality of receiving parts in which medicine can be received, the plurality of receiving parts being open upward and configured to allow an operator to manually place the medicine thereinto from above, the manual medicine distributing apparatus comprising:
a plurality of indicators disposed to correspond respectively to the plurality of receiving parts for color-coded indication of those receiving parts into which the medicine should be placed;
a controller part configured to control the plurality of indicators; and
an input part for receiving an external input, wherein
the controller part is:
configured to control indicators of some or all of those receiving parts into which the medicine should be placed out of the plurality of receiving parts to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription input to the input part; and
configured to switch between the first mode and the second mode based on an input by the operator to the input part.

2. The manual medicine distributing apparatus according to claim 1, wherein
the controller part is:
configured to control indicators of some or all of those receiving parts into which the medicine should be placed out of the plurality of receiving parts to be indicated for each type of the medicine, in any one of the first mode in which the indicators are color-coded for indication according to each timing of taking each medicine and a second mode in which the indicators are color-coded for indication according to each quantity of the medicine to be placed into the receiving parts, based on the prescription information on the prescription input to the input part; and
configured to switch between the first mode and the second mode based on the input by the operator to the input part.

3. The manual medicine distributing apparatus according to claim 1, wherein
the controller part is:
configured to control indicators of some or all of those receiving parts into which the medicine should be placed out of the plurality of receiving parts to be indicated for each prescription, in any one of the first mode in which the indicators are color-coded for indication according to each timing of taking each medicine and a second mode in which the indicators are color-coded for indication according to each combination of a type and a quantity of the medicine to be placed into the receiving parts, based on the prescription information on the prescription input to the input part; and
configured to switch between the first mode and the second mode based on the input by the operator to the input part.

4. The manual medicine distributing apparatus according to claim 1, wherein the controller part controls the indicators to indicate whether the indication is in the first mode or in the second mode in a manner identifiable to the operator.

5. The manual medicine distributing apparatus according to claim 1, wherein
the plurality of indicators each comprise a light projector configured to project light to an inner wall surface of a corresponding one of the plurality of receiving parts,
the light projector is capable of projecting light in a color selected from a plurality of colors including at least white to the inner wall surface, and
the controller part can switch from the first mode or the second mode to a third mode in which the light projector projects white light to the inner wall surface.

6. The manual medicine distributing apparatus according to claim 1, wherein
the plurality of indicators each comprise a light projector configured to project light to an inner wall surface of a corresponding one of the plurality of receiving parts,
the light projector can project light in a color selected from a plurality of colors to the inner wall surface, and
the controller part can switch from the first mode to the second mode to a fourth mode in which the light projector projects no light to the inner wall surface.

7. The manual medicine distributing apparatus according to claim 1, wherein
the controller part is configured to switch between:
an individual indication mode in which the indicators of some or all of those receiving parts into which the medicine should be placed out of the plurality of receiving parts are controlled to be indicated for each type of the medicine, in any one of the first mode in which the indicators are color-coded for indication according to each timing of taking each medicine and the second mode in which the indicators are color-coded for indication according to each quantity of the medicine to be placed into the receiving parts, based on the prescription information on the prescription input to the input part; and
a prescription indication mode in which the indicators of some or all of those receiving parts into which the medicine should be placed out of the plurality of receiving parts are controlled to be indicated for each prescription, in any one of the first mode in which the indicators are color-coded for indication according to each timing of taking each medicine and the second mode in which the indicators are color-coded for indication according to each combination of a type and a quantity of the medicine to be placed into the receiving parts, based on the prescription information on the prescription input to the input part,
based on the input by the operator to the input part.

8. A manual medicine distributing apparatus comprising a receiving body comprising a plurality of receiving parts in which medicine can be received, the plurality of receiving parts being open upward and configured to allow an operator to manually place the medicine thereinto from above, the manual medicine distributing apparatus comprising:
a plurality of indicators disposed to correspond respectively to the plurality of receiving parts for color-coded indication of those receiving parts into which the medicine should be placed;
a controller part configured to control the plurality of indicators; and
an input part for receiving an external input, wherein
the plurality of indicators each comprise a light projector configured to project light to an inner wall surface of a corresponding one of the plurality of receiving parts,
the light projector is capable of projecting light in a color selected from a plurality of colors including at least white to the inner wall surface, and
the controller part is configured to switch between:
a position indication mode in which indicators of some or all of those receiving parts into which the medicine should be placed out of the plurality of receiving parts to are controlled to be indicated in any one of a first mode in which the indicators are color-coded for indication according to each timing of taking each medicine and a second mode in which the indicators are color-coded for indication according to at least one of information items for identifying a combination of the medicine to be placed into the receiving parts, based on prescription information on a prescription input to the input part; and
a check mode in which the indicators are controlled in at least one of a third mode in which the light projector projects white light to the inner wall surface and a fourth mode in which the light projector projects no light to the inner wall surface,
based on an input by the operator to the input part.

9. The manual medicine distributing apparatus according to claim 1, comprising a display screen configured to virtually display at least the receiving body, wherein
the plurality of indicators comprise:
receiving body-side indicators disposed on the receiving body; and
screen-side indicators disposed on the receiving body virtually displayed on the display screen, and
the controller part controls each of the receiving body-side indicators and each of the screen-side indicators corresponding to the receiving body-side indicator to be indicated in the same color in the first mode or the second mode.
